(19) United States
(12) Patent Application Publication
(10) Pub. No.: US 2007/0174484 A1
(43) Pub. Date: Jul. 26, 2007

(54) Apparatus and method for high performance checkpointing and rollback of network operations

(75) Inventors: Dan Lussier, Holliston, MA (US); Simon Graham, Bolton, MA (US)

Correspondence Address: Kirkpatrick & Lockhart Preston Gates Ellis LLP;(FORMERLY KIRKPATRICK & LOCKHART NICHOLSON GRAHAM), STATE STREET FINANCIAL CENTER, One Lincoln Street, BOSTON, MA, 02111-2950, US

(73) Assignee: Stratus Technologies Bermuda Ltd., Hamilton (BM)

(21) Appl. No.: 11/337,697

(22) Filed: Jan. 23, 2006

(51) Int. Cl. G06F 15/173

(52) U.S. Cl. 709/238

(57) ABSTRACT

An improved method and apparatus is provided for checkpointing and rollback of network operations. In one embodiment the method includes varying the checkpoint interval in response to a packet deferred timer and buffering data packets that would affect the states of other network devices in a deferred packets queue. The method further generates an outbound packet for transmission to a remote system, buffers the outbound packet until one of a checkpoint or rollback condition is met and varies a checkpoint interval in response to network load. In another embodiment the apparatus includes a transmitter to send an outgoing packet to a remote system, a deferred transmit queue connected to the transmitter and a deferred packet timer that is configured to vary a checkpoint interval based on a predetermined value.

### FIELD OF THE INVENTION

The present invention relates generally to techniques for implementing fault tolerant computer systems, and more particularly to an apparatus and method for checkpointing in fault tolerant computing systems communicating over a network.

### BACKGROUND OF THE INVENTION

With recent advances in technology, computers have been increasingly used to operate critical applications in a variety of fields. These critical applications may affect millions of people and businesses everyday. For example, some of these applications may include providing and maintaining an accurate system for financial markets, monitoring and controlling air traffic, regulating power generation facilities and assuring the proper functioning of life-saving medical devices. It is a crucial requirement of these systems that they remain operational at all times. Despite significant advancements in the development of technologies to minimize failures, computer-based systems still occasionally fail.

When a failure occurs on a typical home or small-office computer, it is generally merely a nuisance. However, hardware or software glitches can irreparably interfere with a mission-critical system. In order to address this challenge, mission-critical systems employ redundant hardware or software to guard against catastrophic failures and provide some tolerance for unexpected faults within the computer system.

Although fault tolerant systems have been developed, the problem still remains how to address faults in fault tolerant computers which are transmitting data across a network in a way that will allow the fault tolerant computer to recover without affecting the state of the computer to which data is transmitted across the network. The present invention addresses this issue.

### SUMMARY OF THE INVENTION

In one aspect, the invention relates to a method for checkpointing and rollback of network operations. In one embodiment, the method includes generating an outbound packet for transmission to a remote system, buffering the outbound packet until one of a checkpoint or rollback condition is met and varying a checkpoint interval in response to network load. In another embodiment, the method also includes the step of transmitting an outbound packet that does not change the state of the remote system. In yet another embodiment of the present invention, the method further includes receiving an inbound packet from a remote system, replicating the inbound packet on a primary replica to a secondary replica and buffering the inbound packet in the secondary replica until a rollback is initiated.

In another aspect, the invention relates to an apparatus for checkpointing and rollback of network operations. In one embodiment of the present invention, the apparatus includes a transmitter to send an outgoing packet to a remote system, a deferred transmit queue connected to the transmitter and a deferred packet timer that is configured to vary a checkpoint interval based on a predetermined value. In another embodiment of the present invention, the apparatus further includes a receiver to receive an incoming packet from a remote system and a receive queue in communication with the receiver. In yet another embodiment of the present invention, the transmitter is configured to intercept an outgoing packet that will affect the state of the remote system and forward it to the deferred transmit queue.

### BRIEF DESCRIPTION OF THE DRAWINGS

These and other aspects of this invention will be readily apparent from the detailed description below and the appended drawings, which are meant to illustrate and not to limit the invention and in which:

FIG. 1 is a block diagram of an embodiment of a redundant hardware system for fault-tolerance and its connection to a network;

FIG. 2 is a block diagram of the overall checkpointing system architecture in accordance with another embodiment of the invention;

FIG. 3 is a flowchart outlining an embodiment of the method for accomplishing checkpointing; and

FIG. 4 is a block diagram of a per-connection optimization apparatus in accordance with an embodiment of the present invention.

### DETAILED DESCRIPTION OF AN EMBODIMENT OF THE PRESENT INVENTION

The apparatus and method for high performance checkpointing and rollback of network operations in a system with redundant hardware will now be described with respect to the preferred embodiments. In this description, like numbers refer to similar elements within various embodiments of the present invention.

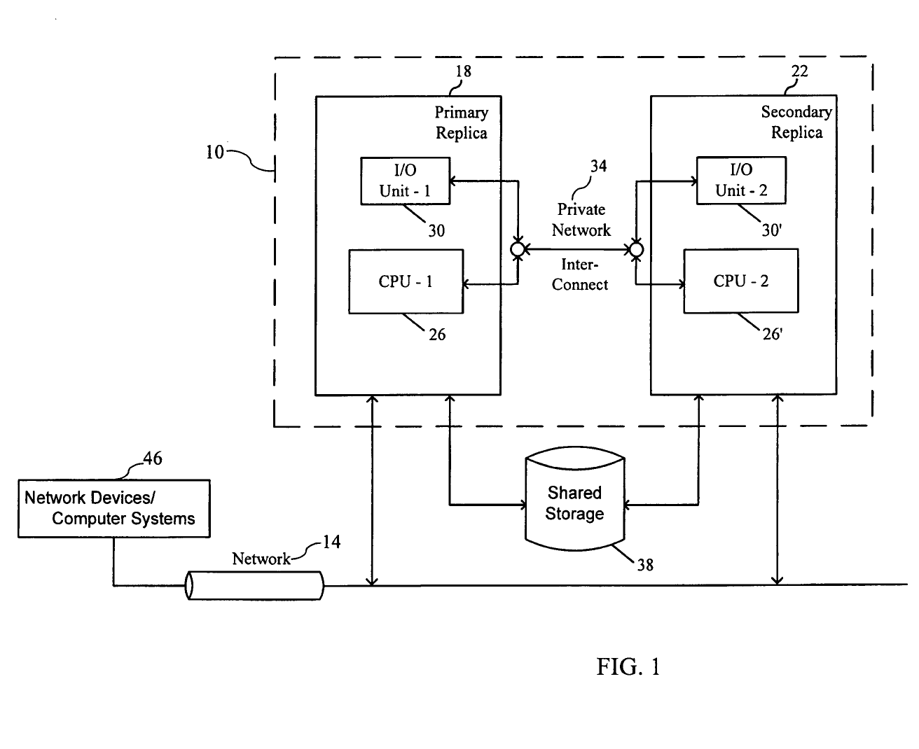

Generally, the present invention relates to an improved apparatus and method for checkpointing and rollback of network operations. In brief overview, FIG. 1 is a block diagram showing an embodiment of a redundant hardware system 10 used for fault tolerant computing and its connection to a network 14. In this embodiment the redundant hardware system 10 includes a primary replica 18 and a secondary replica 22. The replicas 18, 22 are substantially identical computing units that include replicated CPUs 26, 26′ and replicated I/O units 30, 30′ connected by a private interconnect 34. The redundant hardware system 10 is connected to a shared storage 38 and is in communication with a network 14. Other network devices and computer systems 46 are connected to the network 14.

The purpose of the replicas 18, 22 is to execute substantially the same instruction set on the same data to obtain the same result. In this way if the primary replica 18 fails in some manner, the error can be detected and the secondary replica 22 can take over without the loss of data. Because not all operations are atomic, and may include many separate steps, it is difficult, in the event of a failure, to know what was the last “successful” operation performed. To address this difficulty, fault tolerant computers utilize the concept of a checkpoint. A checkpoint is a periodic point in time at which all operations up to that point are known to be successfully completed. This checkpoint then provides a known state to which the computing replicas 18, 22 can return in the case of failure. Additionally, the replicas 18, 22 can be certain that the data and results up to that checkpoint are accurate. The amount of time between checkpoints is termed the checkpoint interval. Typically the checkpoint intervals between sequential checkpoints is a constant value.

In operation, the primary replica 18 executes its instructions and network transmissions and continuously mirrors its current state changes to the secondary replica 22, which are buffered and applied at checkpoints. At each checkpoint, the secondary replica will apply all buffered state changes to its memory so that it represents the exact state of the primary replica at that checkpoint. When an error is detected in the primary replica 18 the secondary replica 22 takes control. The processing is restarted on the secondary replica 22, from the last known good checkpoint state, by simply discarding the state changes it was buffering from the primary replica 18 during the current checkpoint interval but had not applied to memory.

One problem that occurs when a replicated system is attached to a network is that network transactions generally cannot be predicated on a checkpoint. This is because the network recipient of data transmitted from the replica 18 will not know of a failure by replica 18. As a result a rollback to a checkpoint and a restart of operations by the secondary replica 22 could potentially cause the network recipient device 46 to receive the same data from the secondary replica 22, to send different data, or not receive data at all because the connection no longer exists.

One way to avoid this problem is to queue all network transmissions from the primary replica 18 until a checkpoint is reached and then release all the queued transmissions. In this manner, the queued transmissions are known to be the result of completed successful operations and there will be no chance of redundant transmissions by the secondary replica 22. Further by not acknowledging received packets until the subsequent checkpoint, the replica 18 can guarantee that operations using the data in the received packets are complete before acknowledging the receipt of the packet.

However, if network transmissions are delayed until a subsequent checkpoint so that the system can be safely restored to the previous checkpoint, the result is a very severe and unacceptable impact on performance. In particular, for situations where the network traffic is high, delaying network acknowledgment packets until the next checkpoint is generally unacceptable. In order to avoid this degradation in performance the present invention takes a new approach.

First in order to reduce transmission latency generally, the present invention does not simply queue and hold until the next checkpoint all the transmissions from the primary replica 18, but instead queues only those transmissions which would result in changes in the state of the recipient network device 46. Other transmissions which do not result in a change of state of the recipient network device 46 are not queued. Second, to reduce transmission latency in the queued transmissions, the checkpoint interval, the time between checkpoints, is not fixed as in previous systems but varies according to a number of parameters which are discussed below. Finally, packets which are received by the primary replica 18 are copied to the secondary replica 22 and acknowledged in real time.

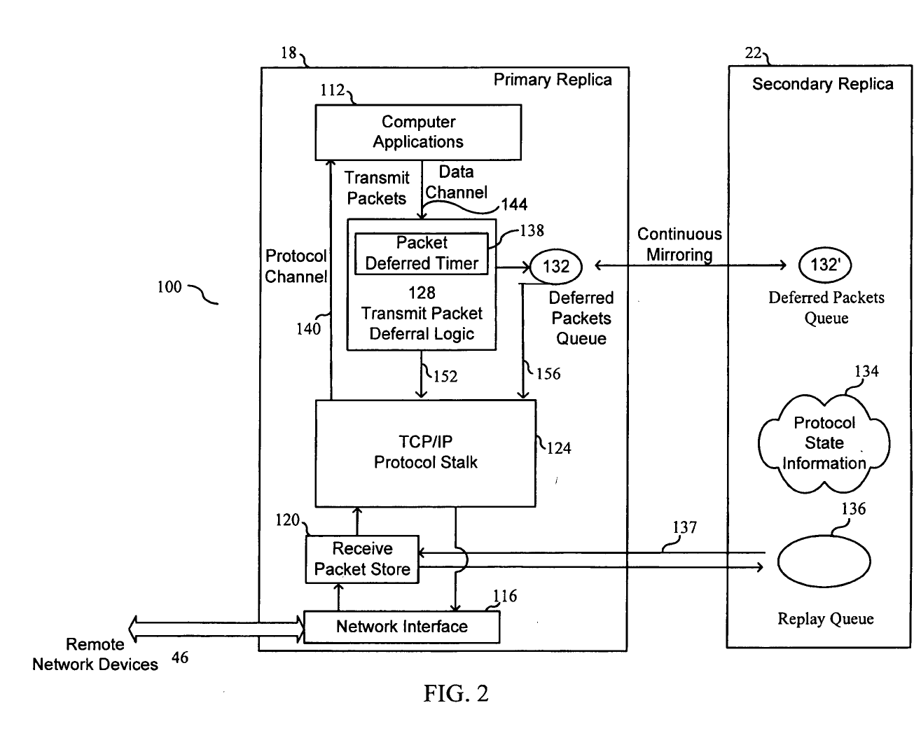

In more detail, and referring now to FIG. 2, a system 100 constructed in accordance with the invention in one embodiment includes the primary replica 18, the secondary replica 22 and remote network devices 46. The primary replica 18 includes a network interface 116 connected to a receive packet store 120. The output packets of the receive packet store 120 are the input packets to a TCP/IP protocol stack 124. The output packets of the protocol stack 124 are the input packets to the applications programs 112. Responses from the application programs 112 are transmitted to the transmit packet deferral logic unit 128. Additionally, in one embodiment a packet deferred timer 138 is provided as part of the transmit packet deferral logic 128. Packets from the transmit packet deferral logic unit 128 are sent either to the TCP/IP protocol stack 124 or the deferred transmit queue 132 depending on whether they affect the state of the remote network devices/computer systems 46. Packets from the deferred transmit queue 132 are sent to the TCP/IP protocol stack 124 before being sent to the network interface 116 for transmission over the network.

The secondary replica 22 includes a second deferred transmit queue 132′ which mirrors the first deferred transmit queue 132, protocol state information 134 and a replay queue 136. The replay queue 136 receives packets from the receive packet store 120 and returns acknowledgements of the receipt of the packet to the receive packet store 120. The second deferred packet queue 132′, the mirrored protocol state information 134 and the replay queue 136 assure that the secondary replica 22 is a mirror of the first replica 18, should the first replica 18 fail.

Considering the operation of the system in terms of each component, data packets from the remote network devices 46 are communicated to the replicas 18, 22 by way of the network interface 116. Both replicas 18, 22 are connected to the same network 14 through the network interface 116. In an embodiment of the present invention, the network interface 116 is a standard network interface card (NIC).

The packet is then transmitted to the TCP/IP protocol stack 124. The TCP/IP protocol stack 124 is a set of network communication protocol layers that define the protocol through which the primary replica 18 will communicate. Each layer operates on the data packets to make modifications before presenting them to the next layer. Additionally, each layer provides a well-defined functional support to higher layers. The higher layers are logically more abstract and interface easily with the user. The lower layers translate data into forms that are easily manipulated as data packets by the system. Data are passed from the protocol stack 124 to the applications 112 by way of a protocol channel 140. Data from the applications 112 are passed to the transmit packet deferral logic 128 by way of transmit packet data channel 144.

The transmit packet deferral logic unit 128 is configured to intelligently determine if the data packets would result in changes in the states of the remote network devices 46. Such packets are buffered in the deferred transmit queues 132, 132′ and the packet deferred timer 138 is activated. If the state of the remote network device 46 would not be affected by the transmission of a packet to the remote network device 26 from the primary replica 18, the transmit packet deferral logic unit 128 sends the packet directly to the TCP/IP protocol stack 124 for immediate transmission.

If the data packet would affect the state of the rem6te network device 46, the packet is not sent to the TCP/IP protocol stack but instead is placed in the deferred packet queue 132 until the next checkpoint occurs. When the checkpoint occurs, the packets in the deferred packet queue are transmitted to the TCP/IP protocol stack 124 for transmission to the network interface 116.

If a failure of the primary replica 18 occurs, the secondary replica 22 takes over communications. As part of the rollback processing, all packets being mirrored from the deferred queue on the primary replica 18 to the secondary replica 22 during the current checkpoint interval are discarded when the state of the secondary replica is restored to the last known good checkpoint state. As part of this rollback on the secondary replica 22 the deferred transmit queue now represents packets that are OK to transmit on the restart. Some of these packets may have already been transmitted by the primary replica 18 prior to its failure. It is not easy to decipher which packets might have been sent and those which have not. How the secondary replica 22 responds to the failure of the primary replica 18 depends, in part, upon whether the protocol associated with the queued packet is a stateless protocol (one that results in no state change by the network device 46) or a stateful protocol (one that results in a change of state of the network device). If the protocol is stateless (such as the UDP protocol) the packets in the secondary replica's 18 deferred packet queue 132′ are discarded. The application using these types of stateless transport protocols must detect and handle the packet loss as it would in any non fault tolerant application. If the protocol is stateful, such as TCP, the secondary replica 22 can queue and transmit these packets since the protocol itself will allow for duplicate transmissions. Some of these packets may represent duplicate transmissions. It is the responsibility of the remote network device 46 to drop duplicate packets, which are detected by the TCP protocol. Similarly, the secondary replica 22 uses the replay queue 136 to provide to the applications all packets that were received from the remote network device 46 since the last checkpoint.

By way of a hypothetical example, consider the Common Internet File System (CIFS) protocol. All requests for sessions under this protocol are sent without any delay or deferral. However, certain file requests are handled differently depending on whether the checkpointing system is on the server side or the client side. If the checkpointing system is on the server side, responses to file requests that can modify a file (e.g. Create, Open for read, and Open for write, Open for delete) are delayed until the next checkpoint. Additionally, responses to Write, Flush, Delete, Close, Rename, Move, Copy and Set-Attributes are also delayed. Responses to Read, Lock, Seek and Get-attributes are sent without delay.

If the checkpointing system is on the client side, file requests that may modify a file (e.g. Create, Write, Flush, Delete, Close, Rename, Move, Copy, Set-Attributes, Open for read, Open for write and Open for delete) are delayed and all others (Read, Lock, Seek and Get-Attributes) sent immediately.

The checkpoint interval may be modified by the packet deferred timer 138. Normally, the checkpoint interval is configured to expire at a predetermined checkpoint interval value. This predetermined value is initially set based on the sensitivity that the protocol or connection has to network delays. The packet deferred timer 138 however, modifies the maximum latency the checkpointing system 100 can introduce into the network when transmitting data packets. by forcing an early checkpoint on the expiration of the packet deferred timer 138. In an embodiment of the present invention, this predetermined value would typically be 2-3 ms.

The packet deferred timer 138 is activated with a predetermined checkpoint delay value when the first transmit packet in a checkpoint interval is buffered in the deferred packet queues 132, 132′. When the value loaded in the packet deferred timer 138 expires, the checkpoint interval is forced complete to permit the checkpoint to be declared and the packet to be released from the queue. The compression of a checkpoint interval by the packet deferred timer 138 in response to network traffic gives rise to variable checkpoint intervals. When high network traffic is detected, the latency in the checkpointing system 100 is reduced without permanently reducing the checkpoint interval. By way of another example, assume the overhead for processing a checkpoint routine is 1 ms and the interval is set for 50 ms. This would mean that the checkpointing system 100 is expected to perform at 98% the efficiency of a non-checkpoint system as can be determined by the following expression:
Performance ratio=checkpoint interval/(checkpoint interval+checkpoint overhead)

If however, the checkpoint interval is reduced to 2 ms, the checkpointing system 100 would sacrifice 33% of its peak performance. Although systems do not usually operate under 100% load, the performance degradation for these reduced checkpoint intervals is noticeable, especially for computer intensive applications with light network loads that would not otherwise require checkpoint intervals. As a result a permanent reduction of the checkpoint interval would incur an additional overhead and is not advisable. Thus the packet deferred timer 138 provides a method of decreasing the checkpoint interval when the deferred packet queue 132 begins to load with deferred packets, without sacrificing performance in the absence of network traffic.

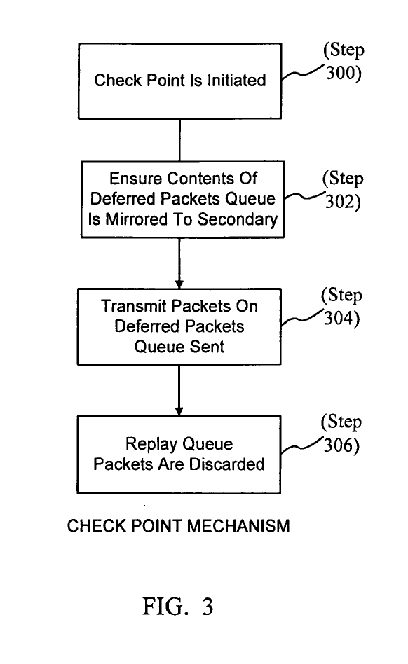

FIG. 3 shows a simple flowchart outlining the steps carried out when the checkpoint mechanism is initiated (Step 300). At this point the system pauses to ensure that the entire contents of the deferred packets queue 132 is mirrored to the secondary deferred packets queue 132 in the secondary replica 22 (Step 302). The packets on the deferred packets queue 132 are de-queued and transmitted (Step 304). The replay queue 136 packets are subsequently discarded (Step 306).

In alternate embodiments of the present invention, the deferral process described above is extended to allow further optimization for per protocol processing. As a consequence of this implementation, the deferred traffic on one connection will not affect the ability to send traffic on a second connection. In addition, the packet deferred timer 138 can be optimized on a per connection basis preferably based on the protocol carried over the connection and its sensitivity to network latency.

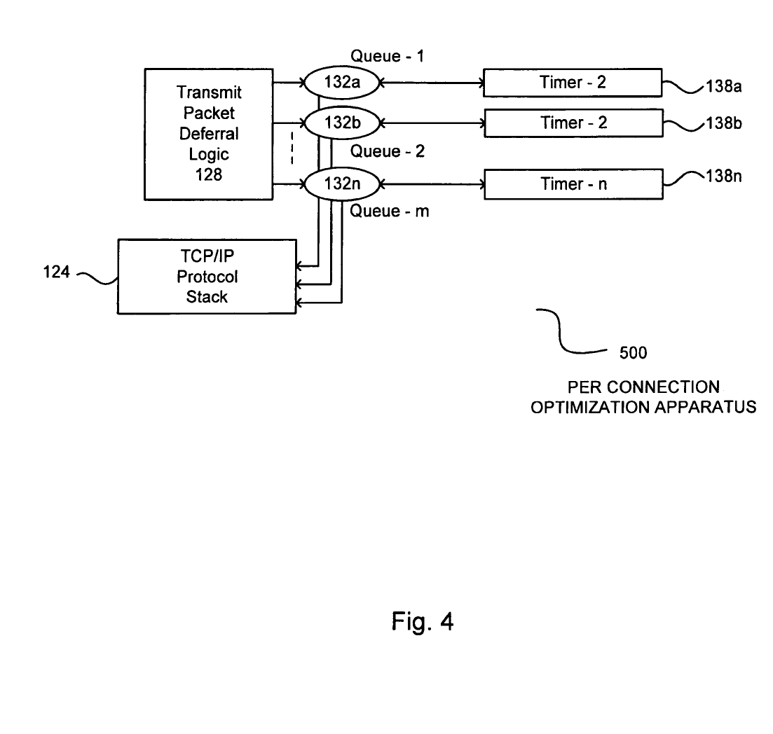

Thus, in one embodiment separate packet deferred queues 132, 132′ are provided for each TCP/IP connection. FIG. 4 shows the per-connection optimization apparatus 500 in accordance with these embodiments. As shown, packet deferred queues, queue-I to queue-n (132a-132n) corresponding to “n” network connections is provided. Each of the “n” packet deferred queues is controlled by its own deferred packet timer, timer-1 to timer-n (138a-138n). Therefore, multiple network connections, each identifiable by an operation performed on the TCP/IP address and port numbers and potentially each having a different protocol, can be established with the remote system.

Those skilled in the art will readily recognize the many benefits and advantages afforded by the present invention. Of significant importance is the substantial improvement in fault-tolerant redundant hardware systems made possible by the improved apparatus and method for checkpointing network operations.

While the invention has been particularly shown and described with reference to the preferred embodiments thereof, it will be understood by those skilled in the art that various changes in form and detail may be made therein without departing from the spirit and scope of the invention.

1. A method for checkpointing network operations, the method comprising the steps of:
generating an outbound packet for transmission to a remote system;
buffering the outbound packet until one of a checkpoint or rollback condition is met; and
varying a checkpoint interval in response to network load.

2. The method of claim 1 further comprising the steps of:
receiving an inbound packet from a remote system;
replicating the inbound packet on a primary replica to a secondary replica; and
buffering the inbound packet in the secondary replica until a rollback is initiated.

3. The method of claim 2 further comprising the step of transmitting an acknowledgment packet in response to an inbound packet.

4. The method of claim 1 further comprising the step of activating a timer when an outbound packet is buffered.

5. The method of claim 4 further comprising the steps of:
loading a predetermined value in the timer; and
starting the timer to begin from the predetermined value.

6. The method of claim 5 further comprising the step of determining the value to be loaded in the timer based on network.

7. The method of claim 5 wherein the step of determining the value to be loaded in the timer additionally is in response to the sensitivity of the system to varying the checkpoint interval.

8. The method of claim 4 further comprising the step of declaring a checkpoint when the timer expires.

9. The method of claim 1 further comprising the step of initiating a rollback mechanism in response to a fault detected on the first replica.

10. The method of claim 9 wherein the step of initiating a rollback mechanism further comprising the steps of:
designating the secondary replica as a new primary; and
relaying the buffered inbound packet for standard protocol processing.

11. The method of claim 10 wherein the step of processing all buffered outbound data packets further comprises the steps of:
dropping a stateless protocol packet; and
retransmitting a stateful protocol packet to the remote system.

12. An apparatus for checkpointing network operations comprising:
a transmitter to send an outgoing packet to a remote system;
a deferred packets queue in communication with the transmitter; and
a deferred packet timer in communication with the deferred transmit queue, the deferred packet timer configured to vary a checkpoint interval based on a predetermined value.

13. The apparatus of claim 12 further comprising:
a receiver to receive an incoming packet from a remote system; and
a receive queue in communication with the receiver, the receiver queue buffering the incoming packet.

14. The apparatus of claim 12 wherein the transmitter is configured to intercept an outgoing packet that will affect the state of the remote system and forward it to the deferred transmit queue.

15. The apparatus of claim 12 wherein the deferred packet timer is configured to initialize to the predetermined value when a first outgoing packet is forwarded to the deferred packets queue.

16. The apparatus of claim 15 wherein the deferred packet timer is further configured to declare a checkpoint when the timer expires.

17. The apparatus of claim 12 wherein the deferred packets queue is configured to buffer an outgoing packet until the initiating of a checkpoint.
